(19) United States
(12) Patent Application Publication
(10) Pub. No.: US 2012/0103738 A1
(43) Pub. Date: May 3, 2012

(54) HYDRAULIC DAMPER AND PISTON HEAD ASSEMBLY THEREFORE

(75) Inventor: Geoff Hodgson, Aurora (CA)

(73) Assignee: LITENS AUTOMOTIVE PARTNERSHIP, Woodbridge (CA)

(21) Appl. No.: 13/379,123

(22) PCT Filed: Jun. 25, 2010
(86) PCT No.: PCT/CA10/00972

§ 371 Date: Dec. 19, 2011

Related U.S. Application Data
(60) Provisional application No. 61/219,937, filed on Jun. 24, 2009.

(51) Int. Cl. F16F 9/06; F16F 9/34

(52) U.S. Cl. 188/269

(57) ABSTRACT

A novel hydraulic damper, and a piston head assembly therefore, includes a feature, such as a slot or passage, which permits compressible gases that would otherwise be trapped between the face of a piston head assembly and the hydraulic fluid to instead migrate to a volume within the damper where they will not affect the dampening force produced by the damper. In the illustrated embodiments, the feature can be formed, relatively inexpensively, in the piston head assembly without the remainder of the damper components requiring modification.

### RELATED APPLICATIONS

This application claims priority from U.S. Provisional Patent Application 61/219,937 filed Jun. 24, 2009 and the contents of this provisional patent application are incorporated herein in their entirety.

### FIELD OF THE INVENTION

The present invention relates to a hydraulic damper and to a piston head assembly for such a damper. More specifically, the present invention relates to a hydraulic damper, and a piston head assembly for such a damper, which includes a gas egress to prevent trapped gases from altering the dampening characteristic of the damper.

### BACKGROUND OF THE INVENTION

Hydraulic dampers are well known and are widely used in a variety of applications. Commonly, a hydraulic damper includes a piston which moves in a cylinder partially filled with a hydraulic (incompressible) fluid. When the damper is moved in a first direction, wherein no substantial dampening force is produced, the piston is moved in the cylinder against the hydraulic fluid and a one-way valve is opened by the pressure difference in the hydraulic fluid on opposite sides of the piston. The hydraulic fluid flows through the one-way valve from the higher pressure side of the piston to the lower pressure side of the piston, allowing the piston to move relatively easily in this first, non-dampening, direction.

When the pressure on the one-way valve drops, when the piston stops moving or when the direction of the piston's movement is reversed, the one-way valve closes. Movement of the piston in the second direction, wherein a dampening force is created, requires hydraulic fluid to flow past the piston, as the piston is moved, through a one or more orifices or passages which are provided for purpose.

However, the flow area of these return passages or orifices is smaller than the flow area through the one-way valve and thus, the piston requires a longer period of time or a higher force, or both, to be returned to its start position, thus providing dampening. By selecting the viscosity of the hydraulic fluid, the size of the return passages or orifices and the diameter of the piston, a designer of a hydraulic damper can achieve a variety of dampening rates, as desired.

As is known, hydraulic dampers must include some volume within the damper to provide volume for the hydraulic fluid displaced as the piston moves into the fluid and to accommodate changes in the volume of the hydraulic fluid due to changes in temperature of the fluid. This volume can be filled with any compressible material, such as a closed cell foam or a gas filled bladder and expansion of the hydraulic fluid is compensated for by a compression of the gas. However, in many circumstances, to reduce manufacturing expense, this volume is filled with a compressible gas, such as air or nitrogen, which compresses and expands to compensate for changes in the volume of the hydraulic fluid.

While hydraulic dampers with such gas filled expansion volumes are widely employed, they do suffer from problems. In particular, the present inventor has determined that the gas can migrate within the damper from the expansion volume to the side of the piston which is pressurized during the dampening action of the damper. This migration can result from: inclination, movement or orientation of the damper during storage, transport, assembly and/or operation of the strut. In certain circumstances, compressible gas can also be introduced below the piston during extreme operating conditions of the damper.

When such a migration occurs, and some amount of compressible gas is on the side of the piston which is pressurized during the dampening action of the damper, movement of the piston in the dampening direction will first result in compression of the compressible gas until that gas is pressurized to the pressure required to force the hydraulic fluid to return to the other side of the piston through the return orifices or passages.

As will be apparent to those of skill in the art, this compression of the compressible gas on the side of the piston which is pressurized during the dampening action of the damper before forcing the hydraulic fluid of through the return passages or orifices results the damper producing a two-stage dampening function, where relatively little dampening force is provided while the compressible gas is compressed and pressurized and the damper is moved through a first range of movement and then a relatively higher (and desired) dampening force is provided as the hydraulic fluid is forced through the return passages or orifices and the damper moves through a second range of movement. While in some circumstances such a two-stage dampening function can be tolerated, in at least some applications it is a significant problem

Accordingly, it is desired to have a hydraulic damper which does not substantially suffer from the effects of compressible gas which may accumulate below the piston of the damper.

### SUMMARY OF THE INVENTION

It is an object of the present invention to provide a novel hydraulic damper and piston head assembly therefore which obviates or mitigates at least one disadvantage of the prior art.

According to a first aspect of the present invention, there is provided a hydraulic damper comprising: a first body including a mounting portion and a cylindrical portion; a second body including a mounting portion and a cylindrical portion, the cylindrical portion inter-engaging the cylindrical portion of the first body to form a volume therewithin, the volume containing a quantity of hydraulic fluid and including a storage volume of compressible gas to provide compensation for changes in the volume of the hydraulic fluid; a piston shaft extending from one of the first and second bodies into the formed volume; a piston head assembly affixed to the piston shaft, the piston head assembly including a face adjacent the hydraulic fluid, an outer cylindrical surface and a one way valve to permit the flow of hydraulic fluid through the piston head assembly when the first body is moved in a first direction with respect to the second body and to inhibit the flow of hydraulic fluid through the piston head assembly when the first body is moved with respect to the second body in a second direction opposite the first direction, the outer cylindrical surface being sized to closely engage the inner surface of the formed volume to meter the flow of hydraulic fluid past the piston head assembly when the first body is moved in the second direction, the metering of the flow of hydraulic fluid producing a dampening force; and a feature formed between the face of the piston head assembly and outer cylindrical surface to permit compressible gases to migrate from the face of the piston to the storage volume.

According to another aspect of the present invention, there is provided a piston head assembly for a hydraulic damper, the assembly comprising: a piston shaft attachment; a piston body having a cylindrical outer surface sized to closely engage the inner surface of the interior volume of the damper to meter the flow of hydraulic fluid past the piston head assembly between the cylindrical outer surface and the inner surface; a one way valve to permit flow of hydraulic through the piston head assembly in a first direction and to inhibit hydraulic fluid flow in a direction opposite to the first direction; and a feature extending from the face of the piston body to the outer cylindrical surface to permit compressed gases which would otherwise be trapped adjacent the piston face to migrate to the outer cylindrical surface.

The present invention provides a novel hydraulic damper that includes a feature, such as a slot or passage, which permits compressible gases that would otherwise be trapped between the face of a piston head assembly and the hydraulic fluid to instead migrate to a volume within the damper where they will not affect the dampening force produced by the damper. In the illustrated embodiments, the feature can be formed, relatively inexpensively, in the piston head assembly without the remainder of the damper components requiring modification.

### BRIEF DESCRIPTION OF THE DRAWINGS

Preferred embodiments of the present invention will now be described, by way of example only, with reference to the attached Figures, wherein:

FIG. 1 shows a side cross section through a prior art hydraulic damper;

FIG. 1a shows an expanded view of the area within area A of FIG. 1;

FIG. 2 shows a perspective view of the bottom and side of a first body of the damper of FIG. 1;

FIG. 3 shows force versus displacement plots of the first body of FIG. 2 towards a second body of the damper of FIG. 1;

FIG. 4 shows a perspective view of the bottom and side of a first body of a damper in accordance with the present invention;

FIG. 5 shows a cross section view of a portion of a hydraulic damper in accordance with the present invention showing detail of the piston head assembly of the damper;

FIG. 6 shows a cross section view of a portion of a hydraulic damper in accordance with the present invention showing detail of the piston head assembly of the damper; and

FIG. 7 shows a perspective view of the bottom and side of the first body of the damper of FIG. 6.

### DETAILED DESCRIPTION OF THE INVENTION

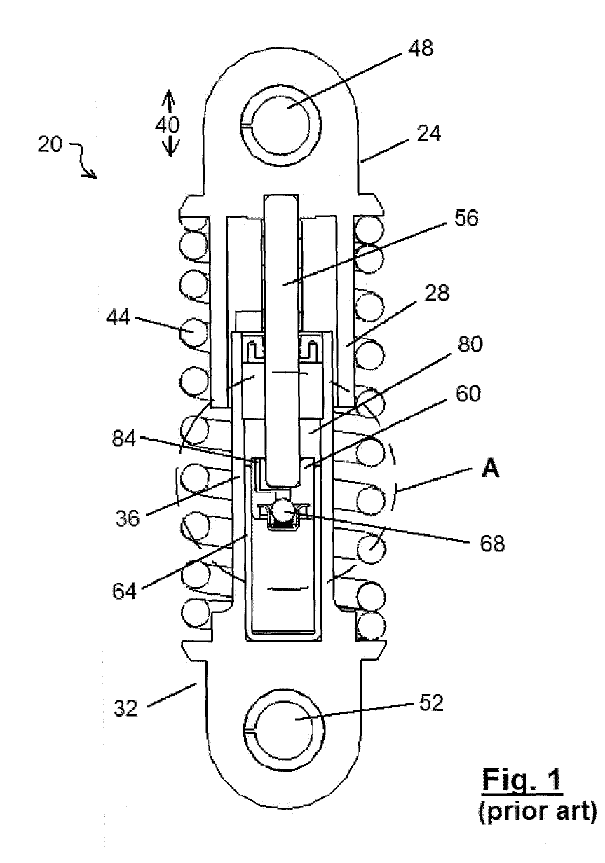

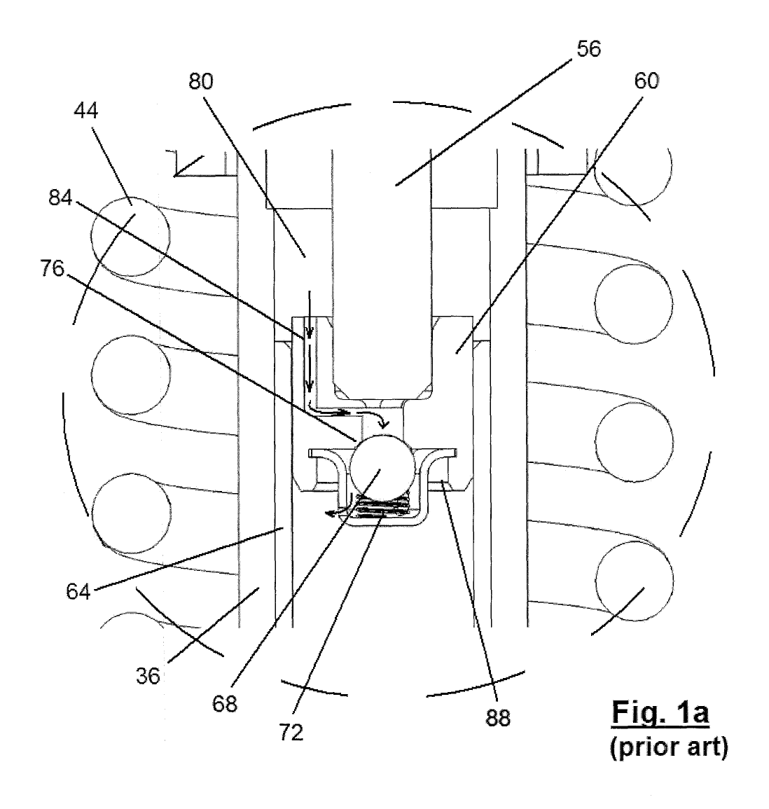

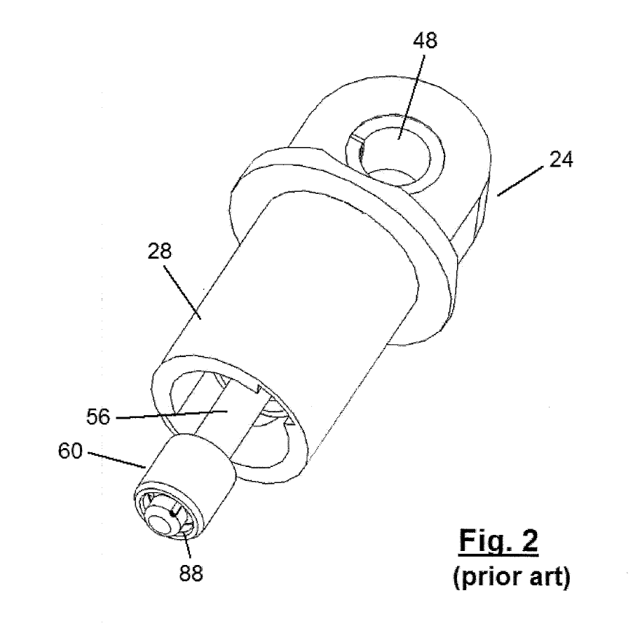

Before discussing the present invention in detail, a prior art hydraulic damper, indicated at 20 in FIGS. 1, 1a and 2 will first be discussed for clarity.

Hydraulic damper 20 includes a first body 24, which includes a first cylindrical portion 28, and a second body 32 which includes a second cylindrical portion 36. The diameters of first cylindrical portion 28 and second cylindrical portion are sized such that second cylindrical portion 36 is received within first cylindrical portion 28 such that first body 24 can move linearly with respect to second body 32 along an operational axis 40 of damper.

As illustrated, damper 20 can include a biasing spring 44, and each of first body 24 and second body 32 can include a mounting feature 48 and 52 respectively.

First body 24 includes a piston shaft 56 which extends from within cylindrical portion 28 into cylindrical portion 36 and piston shaft 56 includes a piston head assembly 60. Second cylindrical portion 36 includes a sleeve 64 which contains a supply of hydraulic fluid (not shown) and the outer cylindrical surface of piston head assembly 60 fits within sleeve 64 such that it is in a close, but not fluid tight, engagement (discussed further below) with sleeve 64.

As best seen in FIG. 1a, piston head assembly 60 includes a one-way valve comprising a ball bearing 68 and a spring 72. Spring 72 biases ball bearing 68 into a valve seat 76 and when damper 20 is compressed, moving piston head assembly downwards in FIGS. 1 and 1a, ball bearing 68 is in a sealing engagement with valve seat 76 and hydraulic fluid cannot flow past ball bearing 68. Instead, the hydraulic fluid which is pressurized and displaced by the compression of damper 20, flows between the outer cylindrical surface of piston head assembly 60 and the inner surface of sleeve 64. As mentioned above, the clearance between the outer cylindrical surface of piston head assembly 60 and the inner surface of sleeve 64 is not fluid tight and, in fact, is selected to permit a desired amount of flow of hydraulic fluid past piston head assembly 60 when damper 20 is compressed and this restricted flow of hydraulic fluid is the basis of the dampening force produced by damper 20.

As is known to those of skill in the art, the desired amount of flow can also be regulated by providing striations or other features in valve seat 76 or in the cylindrical surface of piston head assembly 60 or on the inner surface of sleeve 64, or by providing a metered orifice through piston head assembly 60, or by any of a variety of other known techniques.

When the compressive force applied to damper 20 is removed, spring 44, or another applied external force, biases first body 24 away from second body 32. When this occurs, hydraulic fluid located in the volume 80 above (in the orientation shown in FIGS. 1 and 1a) piston head assembly 60 is pressurized and displaced and this fluid acts against ball bearing 68 and spring 72 of the one-way valve such that ball bearing 68 is moved out of sealing engagement with valve seat 76 and hydraulic fluid can flow through the bore 84 in piston head assembly 60 and past ball bearing 68, through the return path illustrated by the arrows in FIG. 1a.

As should be apparent to those of skill in the art, the return path for the hydraulic fluid through the one way valve is much less restricted than the flow path the hydraulic fluid followed between the outside cylindrical surface of piston head assembly 60 and the inner surface of sleeve 64 and thus little, if any, dampening force is produced as first body 24 is moved away from second body 32.

While damper 20 is illustrated as providing a dampening force when first body 24 is moved towards second body 32 (i.e.—damper 20 is under compression), it will be apparent to those of skill in the art that it is a straightforward matter to redesign damper 20 to reverse this action, so that the dampening force is provided when first body 24 is moved away from second body 32 (i.e.—damper 20 under tension). Principally, the action of the one way valve will be reversed but other changes, as will be apparent to those of skill in the art, will also be effected to damper 20 to reverse the direction in which the dampening force is produced. Accordingly, while the discussion herein is primarily directed to dampers which provide a dampening force while under compression, the present invention is not so limited and it is intended that hydraulic dampers producing a dampening force under either compression or tension can embody the present invention.

However, the present inventor has determined that a problem exists with damper 20, and similar dampers in that compressible gas can become trapped underneath piston head assembly 60, between piston head assembly 60 and the hydraulic fluid below it. As used herein, the term compressible gas is intended both to comprise gas, or mixtures of gasses, and/or foam (comprising bubbles of gases which can be formed within the hydraulic fluid) which can be formed within damper 20 under some operating conditions.

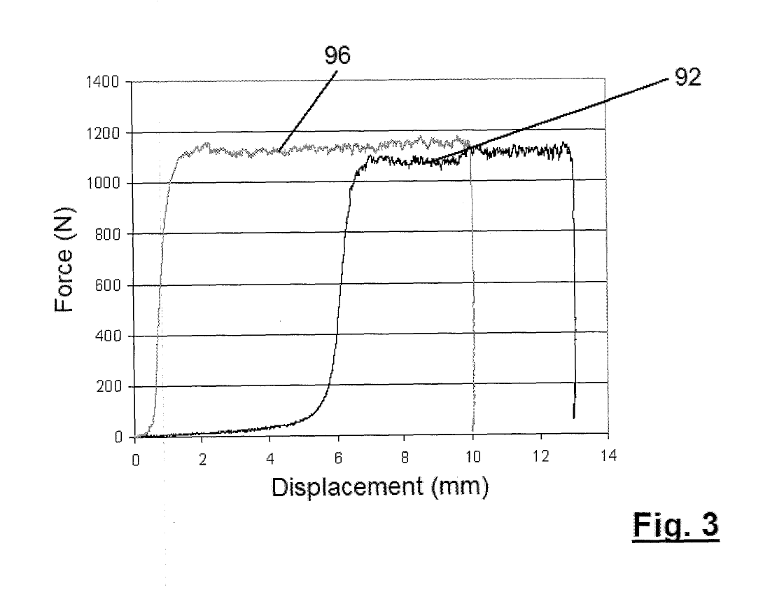

As best seen in FIG. 2, piston head assembly includes a recess 88 in which compressible gasses can be trapped. The effect of compressible gasses being trapped in recess 88 is shown in the plots of FIG. 3 wherein plot 92 shows the dampening performance of damper 20 when compressible gas is present in recess 88 and plot 96 shows the dampening performance of damper 20 when no compressible gas is present in recess 88.

As can be seen from plot 92, when compressible gas is present in recess 88, a significant movement (approximately 5 mm in this particular example) of first body 24 with respect to second body 32 occurs before any significant amount of dampening occurs, whereas when no compressible gas is present in recess 88, as shown by plot 96, damper 20 produces a dampening force after 0.5 mm, or less, of movement of first body 24 towards second body 32. The delayed response in the force verses displacement profile of plot 92 is often referred to as a “compression lag” or a “lost motion effect”, and describes a physical situation whereby there is a measurable linear displacement which is not accompanied by a typical or commensurate dampening force response, typically due to the existence of some unexpected mitigating factor, mechanical defect, deficiency, or phenomenon within the mechanism.

As is known to those of skill in the art, compression lag or lost motion effects can be particularly detrimental in some applications. For example, if damper 20 is to provide dampening for a drive belt tensioner, compression lag of dampener 20 can result in slippage of the drive belt. In particular, if the tensioner is used in a belt alternator starter system, such slippage is entirely unacceptable.

While the results illustrated in FIG. 3 are for a specific prior art damper 20, the present inventor has determined that similar results are obtained with prior art dampers when compressible gasses are trapped between the underside of piston head assembly 60 and the hydraulic fluid within the damper. In these prior art dampers, initial movement of the first body merely results in the compression of the compressible gasses and in little, if any, flow of the hydraulic fluid and thus significant movement of first body towards second body can occur before the prior art damper provides any dampening.

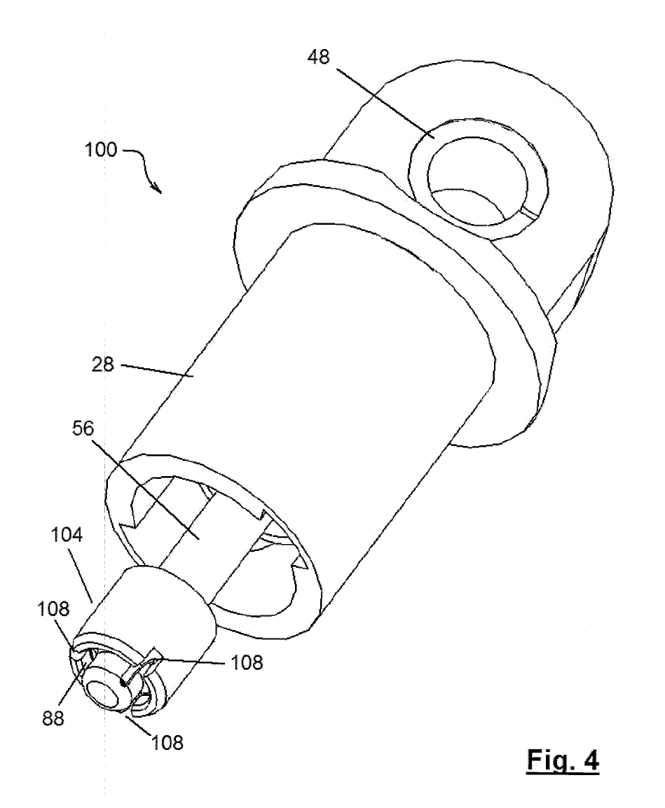

A first embodiment of the present invention will now be described, by way of example only, with reference to FIG. 4 wherein a first body of a hydraulic damper in accordance with the present invention is indicated generally at 100. In the Figures, components which are similar to those of prior art damper 20 are indicated with like reference numerals.

As can be seen in the Figure, in this embodiment of the present invention a novel piston head assembly 104 includes at least one slot 108 is formed from recess 88 upwards and through the lower periphery of the outer cylindrical wall of piston head assembly 104. As should be apparent to those of skill in the art, slot 108 allows compressible gasses, which would otherwise be trapped in recess 88, to migrate to the outer cylindrical surface of piston head assembly 104 and from there, to migrate upwards between piston head assembly 104 and sleeve 64 to accumulate in volume 80.

With the compressible gas no longer being trapped in recess 88, the performance of a damper formed with first body 100 is substantially that indicated by plot 96 of FIG. 3.

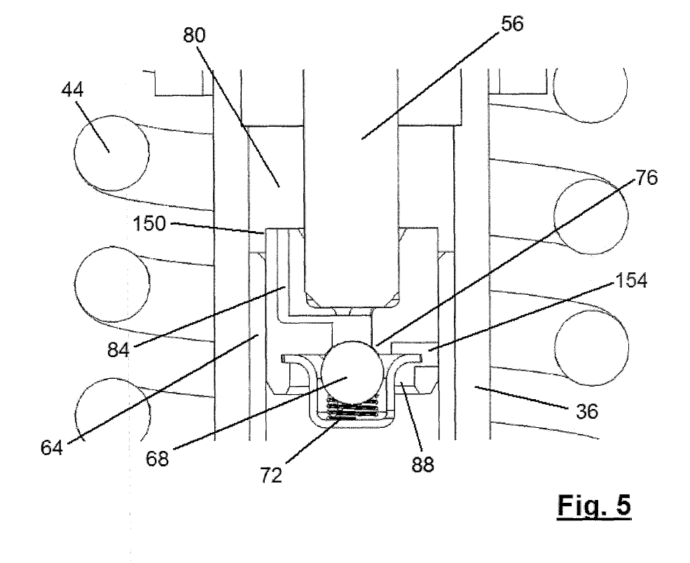

Another embodiment of the present invention is shown in FIG. 5. In this embodiment, wherein like components to those discussed above are indicated with like reference numerals, a novel piston head assembly 150 includes a passage 154, formed by cross drilling or any other suitable means. Passage 154 allows compressible gasses, which would otherwise be trapped in recess 88, to migrate from recess 88 through passage 154 and then upward between the outer cylindrical surface of piston head assembly 150 and sleeve 64 to volume 80.

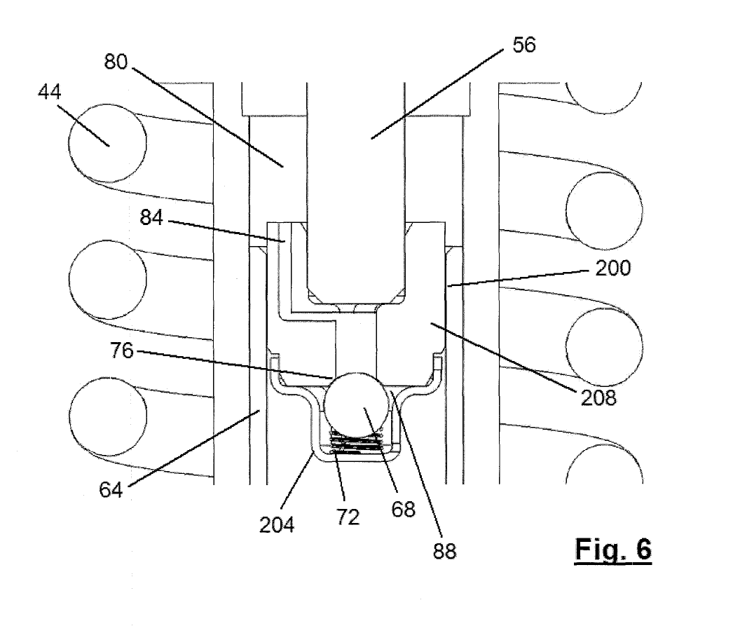

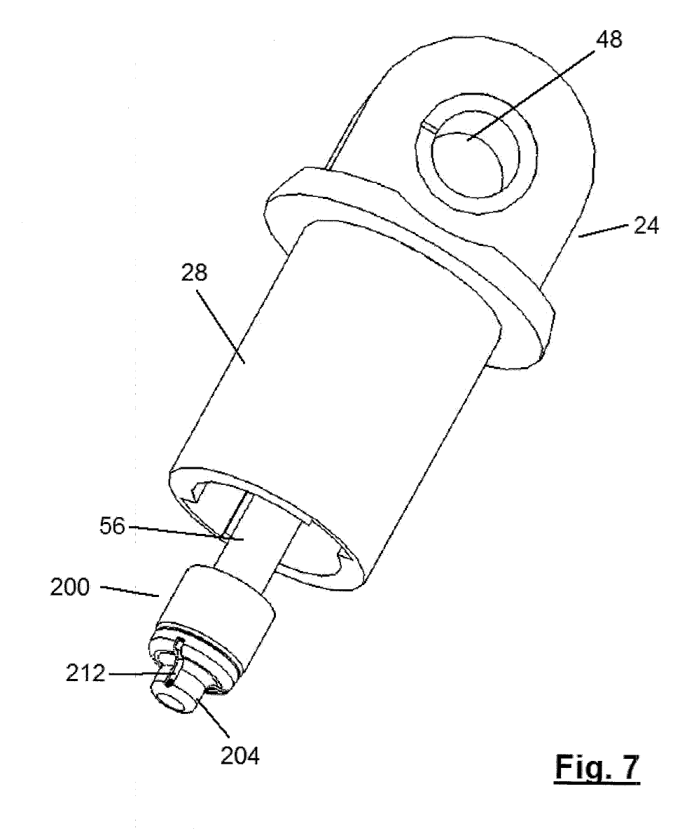

Another embodiment of the present invention is shown in FIGS. 6 and 7. In this embodiment, wherein like components to those discussed above are indicated with like reference numerals, a novel piston head assembly 200 includes a cap 204 which is press fit, or otherwise suitably affixed to, piston head body 208 to retain ball bearing 68 and spring 72 in place on piston head assembly 200. As is best seen in FIG. 7, cap 204 includes a slot 212 which allows compressible gases which would otherwise be trapped in recess 88, inside of cap 204, to migrate from recess 88, through slot 212 and between the outer cylindrical surface of piston head assembly 200 and sleeve 64 to volume 80.

The present invention provides a novel hydraulic damper, and a piston head assembly therefore, which includes a feature, such as a slot or passage, which permits compressible gases that would otherwise be trapped between the face of a piston head assembly and the hydraulic fluid to instead migrate to a volume within the damper where they will not affect the dampening force produced by the damper. In the illustrated embodiments, the feature can be formed, relatively inexpensively, in the piston head assembly without the remainder of the damper components requiring modification.

The above-described embodiments of the invention are intended to be examples of the present invention and alterations and modifications may be effected thereto, by those of skill in the art, without departing from the scope of the invention which is defined solely by the claims appended hereto.

We claim:

1. A hydraulic damper comprising:
a first body including a mounting portion and a cylindrical portion;
a second body including a mounting portion and a cylindrical portion, the cylindrical portion inter-engaging the cylindrical portion of the first body to form a volume therewithin, the volume containing a quantity of hydraulic fluid and including a storage volume of compressible gas to provide compensation for changes in the volume of the hydraulic fluid;
a piston shaft extending from one of the first and second bodies into the formed volume;
a piston head assembly affixed to the piston shaft, the piston head assembly including a face adjacent the hydraulic fluid, an outer cylindrical surface and a one way valve to permit the flow of hydraulic fluid through the piston head assembly when the first body is moved in a first direction with respect to the second body and to inhibit the flow of hydraulic fluid through the piston head assembly when the first body is moved with respect to the second body in a second direction opposite the first direction, the outer cylindrical surface being sized to closely engage the inner surface of the formed volume to meter the flow of hydraulic fluid past the piston head assembly when the first body is moved in the second direction, the metering of the flow of hydraulic fluid producing a dampening force; and
a feature formed between the face of the piston head assembly and outer cylindrical surface to permit compressible gases to migrate from the face of the piston to the storage volume.

2. A hydraulic damper according to claim 1 wherein the first and second bodies are biased apart by a biasing spring.

3. A hydraulic damper according to claim 1 wherein the feature comprises at least one radial bore extending from the outer cylindrical surface to the face of the piston.

4. A hydraulic damper according to claim 1 wherein the feature comprises at least one slot extending from the piston face to the outer cylindrical surface.

5. A hydraulic damper according to claim 1 wherein the one way valve comprises a ball bearing which is biased against a valve seat by a spring, the ball bearing and spring being retained on the face of the piston head assembly by a cap affixed to the piston head assembly and wherein the feature comprises at least one slot formed in the press fit cap.

6. A piston head assembly for a hydraulic damper, the assembly comprising:
a piston shaft attachment;
a piston body having a cylindrical outer surface sized to closely engage the inner surface of the interior volume of the damper to meter the flow of hydraulic fluid past the piston head assembly between the cylindrical outer surface and the inner surface;
a one way valve to permit flow of hydraulic through the piston head assembly in a first direction and to inhibit hydraulic fluid flow in a direction opposite to the first direction; and
a feature extending from the face of the piston body to the outer cylindrical surface to permit compressed gases which would otherwise be trapped adjacent the piston face to migrate to the outer cylindrical surface.

7. The piston head assembly of claim 6 wherein the feature comprises a slot formed from the piston face to the outer cylindrical surface.

8. The piston head assembly of claim 6 wherein the feature comprises a radial bore extending through the outer cylindrical surface to the piston face.

9. The piston head assembly of claim 6 wherein the one way valve comprises a ball bearing and a spring, the ball bearing being biased against a valve seat by the spring and the ball bearing and spring are retained on the piston head assembly by a press fit cap and wherein the feature comprises a slot formed in the cap.
